(19) United States
(12) Patent Application Publication
(10) Pub. No.: US 2011/0168585 A1
(43) Pub. Date: Jul. 14, 2011

(54) Container Assembly for Storing Peripheral Computer Memory Devices

(75) Inventor: Burkhard Bürgerhoff, Hamburg (DE)

(73) Assignee: Brigitte Helm-Bürgerhoff, Hamburg (DE)

(21) Appl. No.: 12/685,936

(22) Filed: Jan. 12, 2010

(51) Int. Cl. G11B 33/04

(52) U.S. Cl. 206/307

(57) ABSTRACT

A container assembly, comprising: a housing in the form of a right parallelepiped with one side left open, the closed sides being a lower main wall, two lateral walls, a rear wall, and an upper main wall, wherein a plurality of first raised portions of first predetermined shapes is formed on the upper main wall and a plurality of second raised portions of second predetermined shapes are formed at one of said lateral walls, while a plurality of second depressed portions of third predetermined shapes complementary to the second raised portions of said one first lateral wall are formed at the other of said two lateral walls, wherein a plurality of first depressed portions of fourth predetermined shapes complementary to the first predetermined shapes of the first raised portions are formed at the outer surface of the lower main wall, whereby a plurality of such container assemblies can be mutually engaged and thus stacked together by insertion the first raised portion into said corresponding first depressed portions and of the second raised portions into said corresponding second depressed portions formed at the outer surface of the housings of the container assemblies; a rack provided at the surface of the lower main wall in the inside of the housing and extending along a direction parallel to the longitudinal extension of said lateral walls; a pin that is provided at an inner surface of said rear wall; a base that is received and slideably moveable in the housing, said base being provided with a pin-engaging push-lock module and a reduction gear module having a gear in cogging engagement with the rack, wherein the pin-engaging module is engageable with the pin so as to secure the base in the housing, wherein the housing dimensions are adapted such that the inner space of the housing above the base corresponds to the size of a standard hard disk drive such that a standard hard disk drive placed on the base may be received in the housing in a manner free of play; a spring mechanism acting between a point on the inside of the walls within the housing and a rearward portion of the base so as to push the base to move outwards through the opening to project from the housing to the outside thereof, so that the base, when it is secured in the housing with the pin-engaging module engaging the pin, may be opened by pushing the base against the pin, thereby disengaging the push-lock module from the pin, whereupon the spring mechanism moves the base to the extended outward position against the resistance of the reduction gear module cogging with the rack; and a front cover assembled to a front end of the base so that, when the base is secured in the housing with the push-lock module in engagement with a pin, the front cover closes the opening of the housing.

### TECHNICAL FIELD

The present invention relates to container assemblies, and in particular to a container assembly for storing peripheral computer memory devices, which allow to assemble or aggregate container assemblies to form a stacked multi-container assembly arrangement.

### DESCRIPTION OF RELATED ART

With the progress and development of technology, computers have become an indispensable part of modern daily life. While computers offer convenience by providing basic operational functions for editing and storing of information, the related peripherals, such as hard disks, flash drives, flash cards and optical drives are also important accessories that assist computers in expanding their functions and storage capacity, providing external data storage media and maintaining efficient operation. These peripherals are typically not fixed components but are supplied individually as optional accessories which users choose according to their practical needs.

For peripherals that are currently not in use it is desirable that they are properly stored for the sake of mechanical protection and protection of the integrity of the stored data. Furthermore, a proper storage of the peripherals is also desirable to maintain order, safety and tidiness of the collection of peripherals and to allow easy and simple access to and retrieval of a particular desired peripheral. To this end, containers are required for storing the peripherals, but users traditionally tend to store the peripherals in general bags, boxes or desk drawers. Since these general boxes or desk drawers are not specially designed for computer peripherals, they do not provide proper accommodating space therefore. Thus, there is a need for containers that permit to properly accommodate and protect computer peripherals, while storage space is economically used, so as to maintain tidiness. Furthermore, the container arrangement should allow to add further container assemblies over time when the number of computer peripherals to be stored increases.

### SUMMARY OF THE INVENTION

In view of the aforementioned needs the inventor of the present invention, by exercising his imagination, creativity, and use of experience and conducting repeated trials and modifications, invented an improved container assembly as disclosed herein.

The first objective of the present invention is to provide a container assembly that allows a plurality of such container assemblies to be mutually engaged by inserting first raised portions into corresponding first depressed portions and second raised portions into corresponding second depressed portions at the outer surfaces of the container assemblies so that a stacked arrangement of container assemblies (vertically and/or transversely stacked) may be achieved, thus improving tidiness and accessibility of the computer peripherals contained in the container assemblies.

The second object of the present invention is to provide such a container assembly that, when a front cover thereof is pressed, a base is disengaged and moved to project from the housing of the container assembly to allow to conveniently place, remove or arrange the computer peripherals. After pushing the base back into the housing the base comes into a secured position within the housing again. The structure and operation of the container assembly not only provides convenience but also improves the reliability of the storage of the computer peripherals.

These and other objects are achieved by a housing in the form of a right parallelepiped with five sides closed and the remaining side left open as an opening, the closed sides being a lower main wall, two lateral walls, a rear wall, and an upper main wall, wherein a plurality of first raised portions of first predetermined shapes are formed at the outer surface of the upper main wall and a plurality of second raised portions of second predetermined second shapes are formed at an outer surface of one of said lateral walls, while a plurality of second depressed portions of third predetermined shapes complementary to the second raised portions at said one of said lateral wall are formed at an outer surface of the other lateral wall, wherein a plurality of first depressed portions of fourth predetermined shapes complementary to the first predetermined shapes of the first raised portions are formed at the outer surface of the lower main wall, whereby a plurality of such container assemblies can be mutually engaged and thus stacked together by insertion the first raised portion into said corresponding first depressed portions and of the second raised portions into said corresponding second depressed portions formed at the outer surface of the housings of the container assemblies, wherein the housing is composed of two housing members which are secured to each other to form the housing; a rack is provided at the surface of the lower main wall in the inside of the housing and extending along a direction parallel to the longitudinal extension of said lateral walls; a pin is provided at an inner surface of said rear wall; a base is received and slideably moveable in the housing, said base being provided with a pin-engaging push-lock module and a reduction gear module having a gear in cogging engagement with the rack, wherein the pin-engaging module is engageable with the pin so as to secure the base in the housing; a spring mechanism is acting between a point on the inside of the walls within the housing and a rearward portion of the base so as to push the base to move outwards through the opening to project from the housing to the outside thereof, so that the base, when it is secured in the housing with the pin-engaging module engaging the pin, may be opened by pushing the base against the pin, thereby disengaging the push-lock module from the pin, whereupon the spring mechanism moves the base to the extended outward position against the resistance of the reduction gear module cogging with the rack; a front cover is assembled to a front end of the base so that, when the base is secured in the housing with the push-lock module in engagement with a pin, the front cover closes the opening of the housing.

### BRIEF DESCRIPTION OF THE DRAWINGS

The invention as well as a preferred mode of use, further objectives and advantages thereof will be best understood by reference to the following detailed description of illustrative embodiments when read in connection with the accompanying drawings, wherein:

FIG. 1. is and exploded perspective view of a container assembly according to a first preferred embodiment of the present invention;

FIG. 2 is a perspective view of the container assembly in an assembled state according to the first preferred embodiment of the present invention;

FIG. 3 shows a perspective views of various kinds of cases that may be place on the base of the container assembly, each of the cases being adapted to properly accommodate a particular kind of computer peripheral;

FIG. 4 shows a perspective view of a container housing that may be used in connection with the container assembly of the present invention;

FIG. 5 shows an exploded perspective view of a container assembly according to a second preferred embodiment of the present invention.

### DETAILED DESCRIPTION OF THE PREFERRED EMBODIMENTS

The container assembly of the present invention comprises a housing in the form of a right parallelepiped with five sides closed and the remaining side left open as an opening. In the preferred embodiment the container housing includes two separate housing members that, when assembled together, form the housing. In the preferred embodiment shown in the Figures the two housing members have the same size, i.e. the right parallelepiped of the housing is separated in the middle between the planes of the lower and upper walls of the container housing. Of course, other ways of dividing the housing into two parts are possible, for example the lateral side walls and the rear wall could extend from one of the upper and lower walls only, whereas the remaining of the upper and lower walls then would simply form a cover to be attached to the remaining housing part.

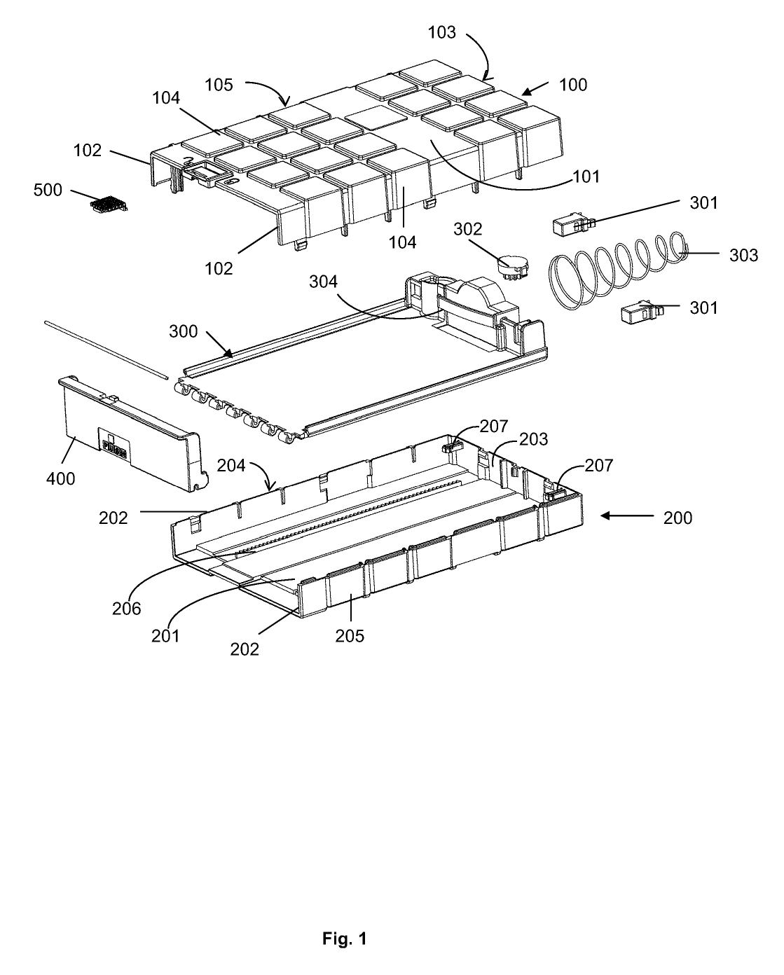

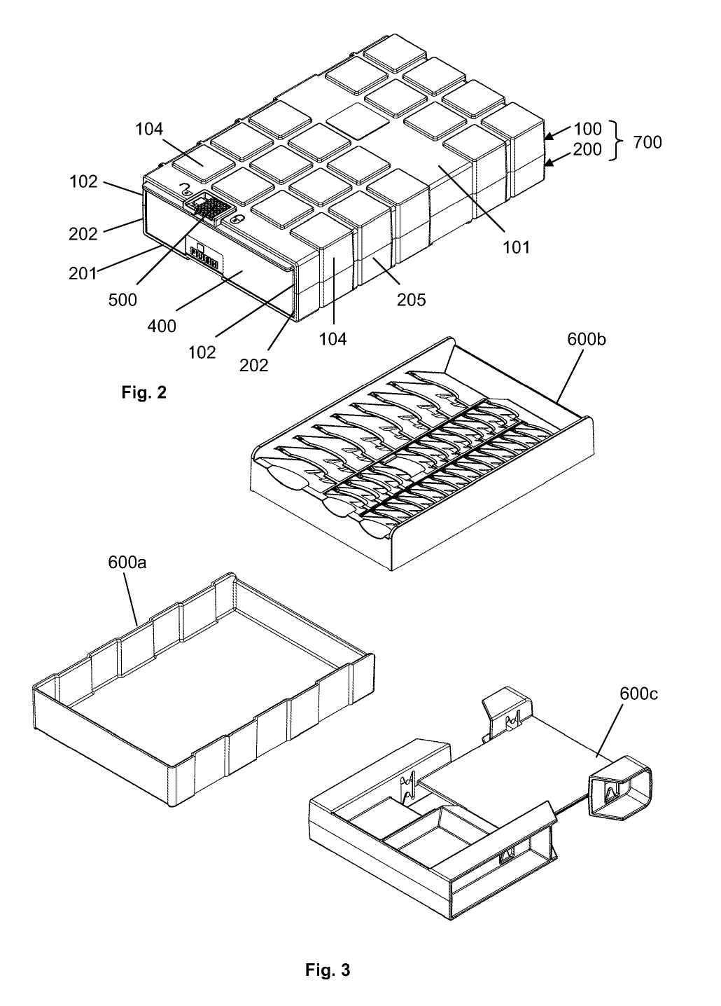

With reference to FIGS. 1 and 2 the container assembly of this embodiment comprises a first housing member 100, a second housing member 200, a base 300, a front cover 400 and a lock unit 500.

The first housing member 100 comprises a first upper main wall 101, two first lateral walls 102 and a first rear wall 103. A plurality of rectangular first raised portions 104 is formed at the outer surface of the first main upper wall 101, and a plurality of rectangular second raised portions 104 is formed at one of the first lateral walls 102, while a plurality of rectangular second depressed portions 105, of complementary shape to the second raised portions, is formed at the outer surface of the other of the two first lateral walls 102. In the embodiment shown the first and second raised portion on the upper main wall and on the one lateral wall, respectively, are of the same dimensions and are located in the same manner and order on the respective surfaces, or in other words the first and second predetermined shapes are the same. However, in general the first raised portion could have different dimensions and distributions as compared to the second raised portions on the lateral wall, as long as it is ensured that the first depressed portions correspond and fit to the first raised portions, and that the second raised portions correspond and fit to the second depressed portions in order to allow stacking of the container assembly in vertical and horizontal direction.

The second housing member 200 includes a second lower main wall 201, two second lateral walls 202, and a second rear wall 203. A plurality of rectangular first depressed portions 204 is formed at the outer surface of the second lower main wall 201, and a plurality of second depressed portions is formed on the second lateral wall 202, while a plurality of second raised portions 205 is formed at an outer surface of the other second lateral wall. The first and the second housing members 100, 200 are coupled together to form a housing 700 in the form of a parallelepiped that has five sides closed and the other side left open as an opening. A rack 206 is provided at an inner surface of the lower main wall 201, and is extending along a direction perpendicular to the side where the opening is formed in the housing, or in other words extending along a direction parallel to the direction of the longitudinal extension of the lateral walls. Two pins 207 are provided at an inner surface of the second rear wall 203 of the second housing member 200.

A base 300 is received in the housing 700 and is arranged to be slideably moveable therein between a first position in which the base 300 is completely received within the housing 700, and an opened position in which the base is moved forward through the opening and projects to the outside of the housing. The base 300 may be guided for the movement between the first and second positions by rails in the housing 700.

The base or tray 300 further comprises two pin-engaging push-lock modules 301, and a reduction gear module 302 having a gear which is in cogging engagement with the rack 206 on the lower main wall of the housing. The pin-engaging push-lock modules 301 are engageable with the pins 207 of the second housing member 200 to secure the base 300 in the first position completely drawn into the housing 700. The pin-engaging push-lock modules are arranged such that they are releasable from the pins 207 by a force pushing the push-lock modules 301 onto the pins 207. In addition there is a provided a spring mechanism 303, which is arranged such that the spring force is acting between the housing 700 and the base 300, for example between the rear wall of a housing and a rear end of the base 300 such that the base is biased to be moved to the second position projecting from the opening of the housing 700. If the base is in the first position locked in the housing with the pin-engaging modules 301 engaging the pins 307 the container assembly may be opened as follows. A push is exerted on the front cover 400 of the base which is transmitted to the push-lock modules 301 which in response thereto disengage from the pins 207. Due to the force provided by the spring 303 the base 300 is then pushed forward to move through the opening of the housing, wherein this movement is controlled by the reduction gear assembly 302 having a gear cogging with the rack 206 and providing a braking force in order to control and slow down the movement of the base 300 from the locked position inside the housing to the extended second position projecting from the housing 700. A stopper (not shown) may be provided to limit the movement of the base 300 to the second extended position and to prevent movement of the base 300 further outside of the housing.

The front cover 400 is assembled to a front side of the base 300 so that, when the base 300 is received in the first position within the housing 700, the front cover 400 properly closes the opening of the housing 700. When the front cover is pressed from outside, the pin-engaging modules 301 are disengaged from the pins 207, and the biasing force of the spring 303 pushes the base 300 outward so that the base 300 is ejected from the housing to the second extended position, wherein this movement is controlled by the reduction gear module 302. Consequently, the base 300 is exposed to facilitate the placement, retrieval and arrangement of objects thereon. After the base is pushed back into the housing 700 by pushing onto the front cover 400, the base 300 is secured in the housing 700 again once the pin-engaging modules 301 are in engagement with the pins 207.

The lock unit 500 is provided at a border between the first main wall 101 of the first housing member 100 and the front cover 400, and serves to engage the front cover 400 with the first main wall 101 so as to fix front cover 400 with respect to the housing 700 for transport to prevent unwanted opening of the front cover 400 and of the base 300.

A plurality of the above described container assemblies can be engaged mutually and thus stacked vertically and/or transversely together by inserting the first raised portions into the corresponding first depressed portions, and/or by inserting the second raised portions into the corresponding second depressed portions formed at the outer surfaces of the housings so that a plurality of container assemblies can be stacked to an engaged arrangement which allows orderly and tidy arrangement of the container assemblies.

In FIG. 3 various cases are shown which may be used in connection with the container assembly. The inner dimensions of the housing are such that it precisely fits to the outer dimension of a PC standard hard disk drive, i.e. a standard hard disk drive placed on the base is received in the housing in a manner free of play. In case other peripherals than standard hard disk drives are to be stored it may be useful to place a case on the base, which case is adapted to the peripherals at issue. For example, a universal case 600a which can hold peripherals of various shapes, but smaller than the standard hard disk drive, may be provided and placed on the base 300 to be carried thereupon. The case 600a is a case adapted to receive a miscellaneous computer peripherals, for example various flash drives such as USB-sticks. Examples of other possible cases are shown in FIG. 3, namely a memory module case 600b for receiving compact flash cards, secure digital cards and similar memory cards; such cards are available with standardised size so that a plurality of small compartments may be provided each for receiving one memory card. Another example is a case for two notebook hard disks 600c which has outer dimensions as a standardised hard disk drives and two compartments, each for receiving one notebook hard disk. Any of the cases 600a, 600b, 600c or a standard hard disk drive can be placed on the base, depending on the actual needs of the user.

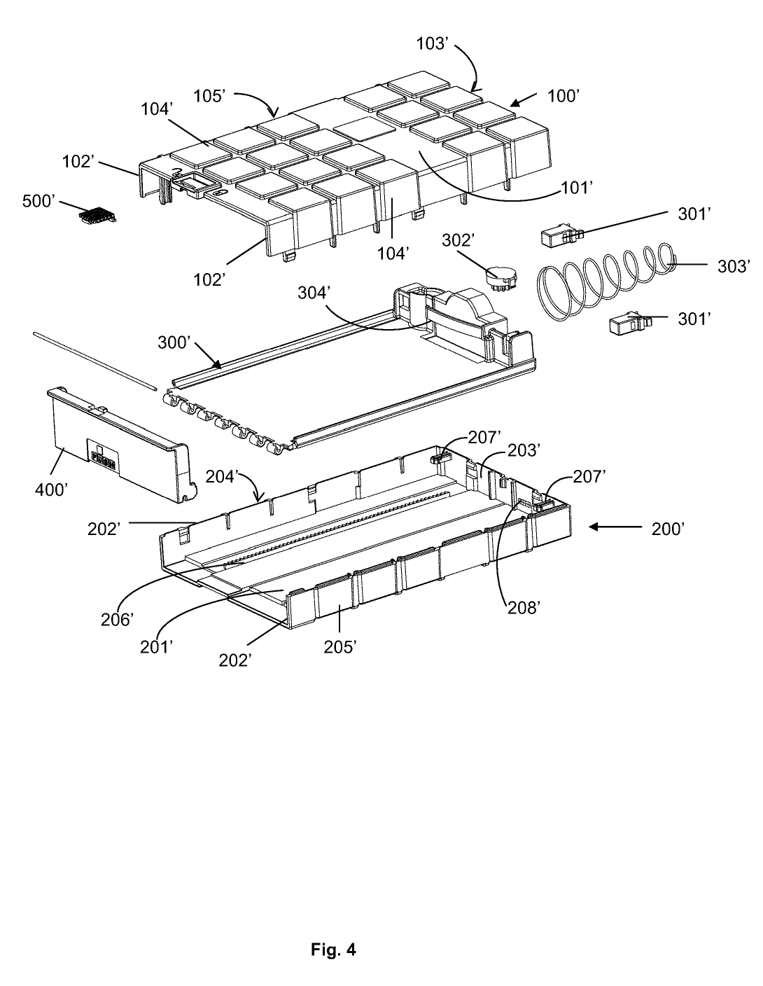

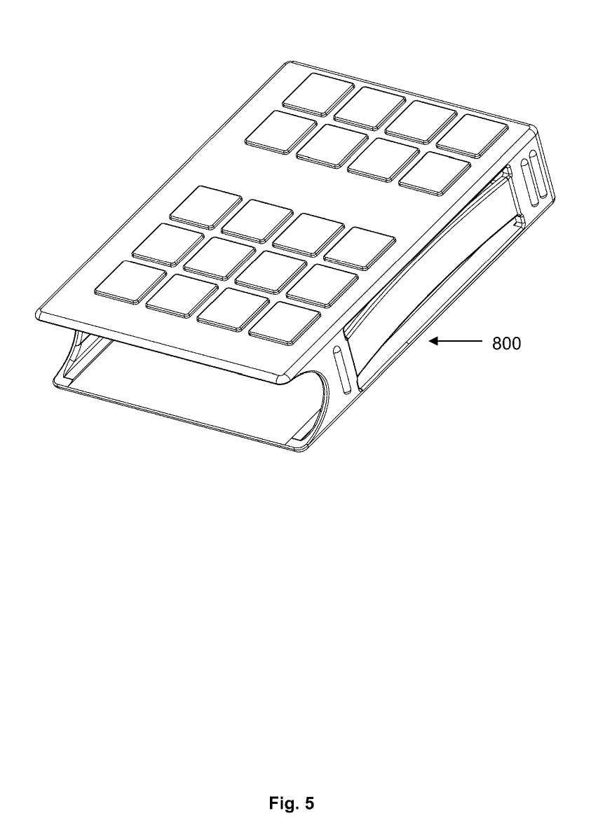

FIG. 4 shows a perspective view of a container housing that may be used in combination with the container assemblies according to the present invention. This container housing exactly corresponds in its inner dimensions to the container assemblies of the present invention, but has no extendable base but simply provides an inner space for accommodating a standard hard disk drive or any of the cases 600a, 600b or 600c. The container housing as shown in FIG. 4 is, due to the missing base and the missing drive and engagement components for the base, of smaller outer dimensions than the container assembly of the present invention. Nethertheless, the container housings may be provided in a corresponding manner to the container assemblies of the present invention with first and second raised portions and complementary first and second depressed portions so that a plurality of container housings as shown in FIG. 4 may be stacked to an engaged arrangement of a plurality of container housings in horizontal and vertical direction.

FIG. 5 shows an exploded perspective view of a container assembly according to a second preferred embodiment of the present invention. The container assembly according to the second preferred embodiment has substantially the same structure as its counterpart in the first embodiment, and therefore the identical structural features are not described again for this embodiment. The second embodiment includes an adapter module 208′ provided on a rear wall 203′ of a second housing member 200′. This adapter module 208′ is arranged such that, when a hard disk drive is received on the base within the housing, an electrical connection is formed between the hard disk drive and the adapter module 208′. To the adapter module 208′ a computer cable may be connected, and thus to the hard disk drive, which computer cable may be connected to an external computer, thereby providing access to the hard disk drive by the external computer.

In connection with the invention a mat of elastomeric material may be used which is placed on a supporting surface of a table or the like where the stacked container assemblies are placed on. This elastomeric mat may be provided with a surface structure corresponding to the surface structure of the upper wall of a container assembly of the present invention. In this manner the mat which is placed on the supporting surface may receive a container assembly according to the present invention in an engaging manner by the surface structure of raised portions of the mat mating with the second depressed portions on the lower surface of the lower main wall of the container assembly. This mat of elastomeric materials serves to prevent the container assembly from slipping on the supporting surface, for example when the front cover of a container assembly is pushed in order to eject the base with the hard disk placed thereon from the container assembly. The lower surface of the mat of elastomeric material may be provided with a surface structure of raised portions that corresponds to the surface structure of the upper wall of a container housing as in FIG. 5. In this manner the elastomeric mat can be used either to support container assemblies of the present invention, or when reversed, to support container housings, wherein in both cases surface structure of raised portions of the mat fits into the complementary structure of depressed portions on the lower surface of a container assembly or a container housing, respectively.

1. A container assembly, comprising:
a housing in the form of a right parallelepiped with five sides closed and the remaining side left open as an opening, the closed sides being a lower main wall, two lateral walls, a rear wall, and an upper main wall, wherein a plurality of first raised portions of first predetermined shapes is formed at the outer surface of the upper main wall and a plurality of second raised portions of second predetermined shapes are formed at an outer surface of one of said lateral walls, while a plurality of second depressed portions of third predetermined shapes complementary to the second raised portions of said one first lateral wall are formed at an outer surface of the other of said two lateral walls, wherein a plurality of first depressed portions of fourth predetermined shapes complementary to the first predetermined shapes of the first raised portions are formed at the outer surface of the lower main wall, whereby a plurality of such container assemblies can be mutually engaged and thus stacked together by insertion the first raised portion into said corresponding first depressed portions and of the second raised portions into said corresponding second depressed portions formed at the outer surface of the housings of the container assemblies, wherein the housing is composed of two housing members which are secured to each other to form the housing;
a rack provided at the surface of the lower main wall in the inside of the housing and extending along a direction parallel to the longitudinal extension of said lateral walls;
a pin that is provided at an inner surface of said rear wall;
a base that is received and slideably moveable in the housing, said base being provided with a pin-engaging push-lock module and a reduction gear module having a gear in cogging engagement with the rack, wherein the pin-engaging module is engageable with the pin so as to secure the base in the housing, wherein the housing dimensions are adapted such that the inner space of the housing above the base corresponds to the size of a standard hard disk drive such that a standard hard disk drive placed on the base may be received in the housing in a manner free of play;
a spring mechanism acting between a point on the inside of the walls within the housing and a rearward portion of the base so as to push the base to move outwards through the opening to project from the housing to the outside thereof, so that the base, when it is secured in the housing with the pin-engaging module engaging the pin, may be opened by pushing the base against the pin, thereby disengaging the push-lock module from the pin, whereupon the spring mechanism moves the base to the extended outward position against the resistance of the reduction gear module cogging with the rack; and
a front cover assembled to a front end of the base so that, when the base is secured in the housing with the push-lock module in engagement with a pin, the front cover closes the opening of the housing.

2. Container assembly according to claim 1, wherein the two housing members separate the housing in two members of equal size in a plane intermediate of the planes of the lower and upper main walls and parallel thereto.

3. The container assembly according to claim 1, wherein a replaceable case carried by the base is provided so as to be received in the housing, wherein the case is adapted to receive a particular digital data carrier, wherein the case is selected from the group of a universal case which provides accommodating space for data carriers of miscellaneous shapes, e.g. USB sticks, a memory module case for receiving compact flash cards, secure digital cards and similar memory cards a comprising a plurality of small compartments each for receiving one memory card, and a notebook hard disk case for receiving two notebook hard disks.

4. The container assembly according to claim 1, wherein the pin-engaging module, the reduction gear module and the spring are attached to the base in a snap-fitting manner.

5. The container assembly according to claim 1, wherein an adapter module is provided in the rear wall of the housing, which adapter module is arranged such that a hard disk drive received on the base in the housing establishes electrical connection with the adapter module to thereby connect the hard disk drive to the adapter, wherein the adapter is further connected to a socket which may be connected to a plug of a standard computer cable to thereby connect the hard disk drive to an external computer.

6. The container assembly according to claim 1, further comprising at least one container housing in the form of a right parallelepiped having an inner space of the same dimensions as the container assembly of claim 1 so that the container housing may receive a standard hard disk drive or any of a plurality of cases adapted to receive a particular digital data carrier, wherein the case is selected from the group of a universal case which provides accommodating space for data carriers of miscellaneous shapes, e.g. USB sticks, a memory module case for receiving compact flash cards, secure digital cards and similar memory cards, comprising a plurality of small compartments each for receiving one memory card, and a notebook hard disk case for receiving two notebook hard disks, wherein the container housing has five sides closed and the remaining side left open as an opening, the closed sides being a lower main wall, two lateral walls, a rear wall, and an upper main wall, wherein a plurality of first raised portions of first predetermined shapes is formed at the outer surface of the upper main wall and a plurality of second raised portions of second predetermined shapes are formed at an outer surface of one of said lateral walls, while a plurality of second depressed portions of third predetermined shapes complementary to the second raised portions of said one first lateral wall are formed at an outer surface of the other of said two lateral walls, wherein a plurality of first depressed portions of fourth predetermined shapes complementary to the first predetermined shapes of the first raised portions are formed at the outer surface of the lower main wall, whereby a plurality of such container housings can be mutually engaged and thus stacked together by insertion of the first raised portion into said corresponding first depressed portions and of the second raised portions into said corresponding second depressed portions formed at the outer surface of the container housings.
